(19) United States
(12) Patent Application Publication
(10) Pub. No.: US 2004/0041813 A1
(43) Pub. Date: Mar. 4, 2004

(54) System on-a-chip processor for multimedia

(75) Inventor: Jae-Hyun Kim, Suwon-city (KR)

Correspondence Address: SUGHRUE MION, PLLC, 2100 PENNSYLVANIA AVENUE, N.W., WASHINGTON, DC, 20037, US

(73) Assignee: SAMSUNG ELECTRONICS CO., LTD.

(21) Appl. No.: 10/633,712

(22) Filed: Aug. 5, 2003

(30) Foreign Application Priority Data
Aug. 30, 2002 (KR) 2002-0052015

(51) Int. Cl. G06F 15/00; G06F 15/76; G06F 13/14

(52) U.S. Cl. 345/519; 712/36

(57) ABSTRACT

A SOC processor for multimedia capable of improving three-dimensional graphic process speed includes a pre-processor circuit unit to convert an image signal transmitted from the outside into a compressed input signal for compressing the image signal, an encoder/decoder circuit unit to create a compressed data by compressing the compressed input signal, and to encode the compressed data, a post-processor to convert the coded image signal so that an image displaying apparatus can use the image signal, a graphic accelerator to process three-dimensional graphic computation with respect to the image signal output on the image displaying apparatus, a first system bus connected with the encoder/decoder circuit unit, a second system bus connected with the pre-processor, post-processor, and graphic accelerator, and a controlling unit to control the above circuit units. The first system bus and second system bus can communicate data each other by a bridge DMA circuit unit.

### BACKGROUND OF THE INVENTION

This application claims foreign priority under 35 USC 119 to Korean Patent Application No. 2002-52015, filed on Aug. 30, 2002, the contents of which is incorporated herein by reference.

1. Field of the Invention

The present invention relates to a SOC (System On-a-Chip) processor, and more particularly to a SOC processor for use in a multimedia device.

2. Description of the Prior Art

As multimedia services become more diverse, related art multimedia devices such as a cellular phone, a PDA (Personal Digital Assistant), a digital television, and a DVDP (Digital Video Disc Player) have been introduced. Accordingly, interest in a processor for the multimedia device has grown.

A multimedia processor has various functions of processing images, controlling LCD (Liquid-Crystal Display)/CRT (Cathode-Ray Tube), and controlling hardware and peripheral devices for video CODEC. It has been developed as a system on a chip (SOC) processor to meet the requirements of price and size reduction.

The related art SOC processor is an IC (Integrated Circuit) having a microprocessor, a built-in memory, a plurality of peripheral devices, and an external bus interface integrated into a single chip. Due to development of the SOC processor, the size of a system can be reduced, and the time required for system testing can be shortened. Moreover, the reliability of the system can be increased, and a product can be launched into a market in a shorter time than before.

A related art SOC multimedia processor integrates circuits for performing various functions needed for a multimedia device into a single chip. The SOC multimedia processor had a circuit of a single function such as DCT (Discrete Cosine Transformer) or ME (Motion Estimator) in its early stage of development. Then, SRAM (Static Random Access Memory) or Boot ROM (Read-only Memory) was added to the processor. In addition, a chip having a large-capacity SDRAM (Synchronous Dynamic Random Access Memory) has been developed, and more functions are required due to technical development.

To design a SOC multimedia processor, a method of using a microprocessor introduced by an existing semi-conductor manufacturer as a core, and adding circuits for performing other functions can be considered, rather than designing the entire processor. For example, a microprocessor such as a CISC (Complex Instruction Set Computer) CPU x86 or 68k, or RISC (Reduced Instruction Set Computer) microprocessor such as ARMTM can be applied as a core controller in a SOC processor.

In the processor, main parts such as a microprocessor, a memory, and an input/output device are connected through a system bus used as a common communication pathway. According to a related art system bus protocol, a system bus provided by the semi-conductor manufacturer that has developed the microprocessor is generally used. By designing a SOC based on that standard, the difficulty in designing with respect to an external interface is reduced and the time required for developing a SOC processor is also reduced.

The foregoing related art has various problems and disadvantages. For example, but not by way of limitation, since the circuits of different clock speeds and processing speeds are provided for the various multimedia processing functions, when the respective circuits use one shared system bus, the computation of an entire system is set to a processing speed of the circuit of the slowest processing speed, or the circuit of the fastest processing speed is in the stand-by state for a lengthened period of time, subsequently degrading the overall performance of the system.

Particularly for graphic signal processing, the process with respect to graphics pipe line is operated based on the connection of the pipe line. Thus when processing speed becomes slow at even one part, the efficiency of an entire system is lowered.

### SUMMARY OF THE INVENTION

The present invention has been made to overcome the above-mentioned problems of the prior art. Accordingly, it is the object of the present invention to provide a SOC processor for multimedia having a means for interfacing between a system bus of an existing semi-conductor manufacturer and a newly designed system bus, and capable of improving the efficiency of the entire system without reducing speed in processing a graphic signal.

The above object of the present invention is realized by providing a system on a chip (SOC) processor for multimedia, comprising: a pre-processor that converts an external image signal into a compressible signal; an encoder/decoder that generates compressed data by compressing the compressible signal, and codes the compressed data to produce a coded image signal; a post-processor that converts the coded image signal into a format for use by an image displaying apparatus; a graphic accelerator that processes three-dimensional graphic computation with respect to the image signal output on the image displaying apparatus; a first system bus coupled to the encoder/decoder circuit unit; and a second system bus coupled between the pre-processor, the post-processor, and the graphic accelerator, wherein the first system bus and the second system bus communicate data to each other through a bridge DMA circuit unit, and a controller controls said pre-processor, said encoder/decoder, said post-processor and said graphic accelerator.

The graphic accelerator includes: a geometry computation unit configured to perform geometry computation in order to display an object; and a rendering computation unit configured to perform rendering computation for color, brightness and visual effect of a graphic of the displayed object.

The SOC processor for multimedia further comprises a texture/pixel cache configured to store two-dimensional information of an object to be displayed and further configured to remove hidden surfaces of the image that has been three-dimensional graphic operated.

Moreover, the SOC processor for multimedia further comprises a buffer connected between the controlling unit and the first system bus, wherein the buffer can store data to be graphic operated by supporting the graphic accelerator. The buffer is implemented by using a SRAM with a dual porter. In addition, the buffer can receive data from an external memory having information of geometry. Here, the external memory is an SDRAM having a clock speed synchronized with that of the controlling unit.

The graphic accelerator receives the stored information by directly accessing to the buffer.

Additionally, a method of performing multimedia processing on a system on a chip (SOC) is provided, comprising the steps of: converting an external image signal into a compressible signal; compressing the compressible signal to generate compressed data, and coding the compressed data to produce a coded image signal; converting the coded image signal into a format for use by an image displaying apparatus; and processing three-dimensional graphic computation with respect to the image signal output on the image displaying apparatus; wherein said compressing is performed in a circuit coupled to a first system bus, and a said converting steps and said processing step are performed in a circuit coupled to a second system bus, such that said first system bus and said second system bus can operate at different respective clock frequencies, and wherein a first system bus and a second system bus communicate data to each other through a bridge DMA circuit unit, and a controller controls said converting steps, said compressing step, and said processing step.

The foregoing steps can also be performed as instructions stored in a computer-readable medium.

The SOC processor for multimedia can process graphic computation without causing load to a controlling unit, and thus the performance of the entire system can be improved.

### BRIEF DESCRIPTION OF THE DRAWINGS

The above-mentioned object and the feature of the present invention will be more apparent by describing the preferred embodiment of the present invention by referring to the appended drawings, in which:

FIG. 1 is a schematic block diagram showing main parts of a SOC processor in accordance with an exemplary, non-limiting embodiment of the present invention; and

FIG. 2 is a detailed block diagram showing the SOC processor of FIG. 1, in accordance with an exemplary, non-limiting embodiment of the present invention.

### DESCRIPTION OF THE PREFERRED EMBODIMENT

Hereinbelow, the present invention will be described in greater detail with reference to the appended drawings.

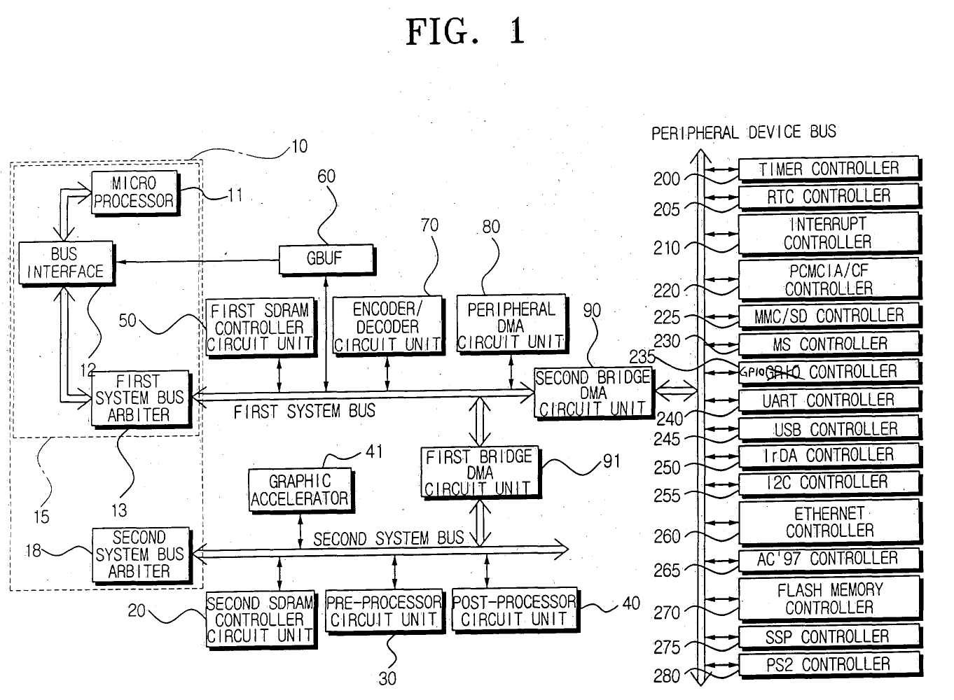

FIG. 1 is a block diagram showing a SOC processor for multimedia according to the present invention, including a controlling unit 10, a first system bus, a second system bus, and a peripheral device bus. Each system bus is configured to operate independently.

The first system bus couples a first SDRAM controller circuit unit 50, an encoder/decoder circuit unit 70 and a peripheral DMA (direct memory access) circuit unit 80. The second system bus couples a second SDRAM controller circuit unit 20, a pre-processor circuit unit 30 and a post-processor circuit unit 40. The peripheral device bus couples a plurality of peripheral device controllers 200 . . . 280 for controlling peripheral devices. A GBUF (General Buffer) 60 is coupled between the controlling unit 10 and the first system bus.

A first bridge DMA circuit unit 91 is coupled between the first system bus and the second system bus, and a second bridge DMA circuit unit 90 is coupled between the first system bus and the peripheral device bus.

The controlling unit 10 controls each circuit unit in the SOC processor, and includes a first system bus controlling unit 15 and a second system bus arbiter 18. The first system bus controlling unit 15 has a microprocessor 11, a bus interface 12, a first system bus arbiter 13 and a bus to couple these parts. The microprocessor 11 of the first system bus controlling unit 15 controls the components of the SOC processor for multimedia. An ARM1020E manufactured by ARM (Advanced RISC Machines LTD.) can be adapted as the microprocessor 11, but the present invention is not limited thereto. In the present invention, an AMBA (Advanced Micro-controller Bus Architecture) introduced by ARM can be used to couple the microprocessor 11 and the bus interface 12.

The AMBA had been designed before memory such as SDRAM or RDRAM (Rambus DRAM) was generally used. Thus, there is no great problem with performance when a memory such as EDO RAM (Extended Data Out RAM) is used. However, when a block access memory is used, the performance of the AMBA can be degraded.

Accordingly, a separate bus architecture to support the block access memory is used between the bus interface 12 and the first system bus arbiter 13. The bus interface 12 interfaces a bus between the microprocessor 11 and the first system bus arbiter 13. A DOAA (Data Oriented Arbitration Architecture) bus, which is well-known in the related art, can be applied as a bus system capable of supporting the block access memory.

The first system bus arbiter 13 arbitrates the controlling unit 10, the first SDRAM controller circuit unit 50, the GBUF 60, the encoder/decoder circuit unit 70, the peripheral DMA circuit unit 80, the first bridge DMA circuit unit 91 and the second bridge DMA circuit unit 90 to access the first system bus. The second system bus arbiter 18 is configured to operate independently from the first system bus arbiter 13, and arbitrates the second SDRAM controller circuit unit 20, the pre-processor circuit unit 30, the post-processor circuit unit 40, a graphic accelerator 41 and the first bridge DMA circuit unit 91 to access the second system bus.

When access to the first system bus and the second system bus controlled by the controlling unit 10 conflict, the priority order therebetween can be decided using various methods by the first system bus arbiter 13 and the second system bus arbiter 18. The priority of the bus access may be provided to a circuit unit requiring a vast amount of data.

The pre-processor circuit unit 30 converts an image signal received from the outside (i.e., an external system) into a signal that can be compressed by a video coder. In other words, a signal input from a CMOS image sensor is converted from a RGB signal into a YUV signal, after a gamma correction is applied in consideration of a CRT characteristic. A signal input from the outside after being converted into a luminance signal Y and color difference signals Cb and Cr can also be processed. Moreover, ITU-R (International Telecommunication Union-Radiocommunication Sector) 601 and 605 formats can be input thereto, and further, a desired format of a signal can be output to the video coder.

The encoder/decoder circuit unit 70 generates compressed data by compressing an input signal, and outputs an encoded image signal by decompressing compressed data. This process is required because a digital image needs to be compressed in order to transmit its large amount of digital image signals, and the compressed image needs to be decompressed for later use.

The encoder/decoder circuit unit 70 requires a large amount of computation to implement video CODEC, which includes image compression standards such as H.263, MPEG-2, MPEG-4 and JPEG. Thus, the computation is performed without using the microprocessor 11. Accordingly, the performance of the system can be improved, as the computation process is performed using hardware thereof.

The post-processor circuit unit 40 coupled with the second system bus controls a LCD or a CRT to display the encoded image signal. The process of the post-processor circuit unit 40 includes the steps of converting a YUV signal into a RGB signal, performing paletting for graphic data in mode with less than 16 bpp, and dithering for additionally displaying colors that are not available.

The post-processor circuit unit 40 supports 4, 8, 16 and 32 bpp for color depth, and has functions of error diffusion and dithering for when the number of gradations of a displaying apparatus is less than that of a digital image.

The graphic accelerator 41 processes computations related to graphic processing using hardware. Generally, graphics are made of many lines and faces, with colors on the lines and faces. Thus, many computations are required for the graphics, and if the microprocessor 11 processes graphic computations, the processing speed of the entire system is slowed down. To avoid this problem, the graphic accelerator 41 is separately provided from the microprocessor 11, and performs graphic computations with respect to the compressed input signals, thus reducing computational requirements of the microprocessor 11 and improving the overall performance of the system.

The graphic accelerator 41 performs two/three-dimensional graphic computations of an image signal to be output to a displaying apparatus. Three-dimensional graphic computations performed by the graphic accelerator 41 are geometry computations and rendering computations, as described below.

The first SDRAM controller 50 coupled with the first system bus and the second SDRAM controller 20 coupled with the second system bus control SDRAMs coupled externally. The SDRAMs are DRAMs with upgraded computation speed that adopt double interleaving and process internal computations using a pipeline method. The SDRAMs synchronize their clock speed with the microprocessor 11 and adopt a burst mode, which rapidly outputs a series of data bit, being set to a clock after a first bit is accessed. The burst mode is useful when all bits to be accessed are accessed in order, and are in the same row with the first bit.

The SOC processor for multimedia inputs and outputs data by using a separate SDRAM for each system bus, considering the difference in speed between the first system bus and the second system bus. As a result, the bottleneck phenomenon generated for bus access is eased. The length of data input into the SDRAM and output from the SDRAM may be 16 bits or 32 bits.

The GBUF 60 coupled between the controlling unit 10 and the first system bus is a buffer similar to a cache memory installed inside the microprocessor 11. The GBUF 60 has almost the same speed as the fastest memory by applying the principle of locality. At the same time the GBUF 60 has a vast amount of memory capacity with a low cost of a semi-conductive memory.

When an ARM1020E processor is applied as the microprocessor 11, that processor has an internal data cache of 32 Kbyte and an internal instruction cache of 32 Kbyte. Therefore, an on chip cache inside the microprocessor 11 plays the role of a first cache, and the GBUF 60 plays the role of a second cache. The GBUF 60 can be used as a supplementary buffer of other circuit units instead of being used as the second cache. In other words, the GBUF 60 can store data to be performed graphic computation assisting the graphic accelerator 41. It is preferable that the GBUF 60 is implemented by a SRAM with a dual porter.

The plurality of peripheral device controllers 200 . . . 280 are coupled with the peripheral device bus. Among the plurality of peripheral device controllers are a TIMER controller 200, an RTC controller 205 and an Interrupt controller 210.

For communication, there are a UART (Universal Asynchronous Receiver-Transmitter) controller 240, an IrDA (Infrared Data Association) controller 250, an I2C (Inter IC control) controller 255 and an Ethernet controller 260.

For memory card control, there are a PCMCIA/CF (Personal Computer Memory Card Interface Association/Compact Flash) controller 220, an MMC/SD (Multi-Media Card/Secure Disk) controller 225 and an MS (Memory Stick) controller 230.

Moreover, there are an AC'97 controller 265 and a flash memory controller 270. Lastly, there are a GPIO (General Purpose Input Output) controller 235, an SSP (Synchronous Serial Protocol) controller 275 for Touch Screen, and a PS2 controller 280. The last three controllers are coupled with the peripheral device bus and control the peripheral devices coupled with the outside. The peripheral DMA circuit unit 80 coupled with the first system bus is used as DMA for the peripheral devices.

On the other hand, the first bridge DMA circuit unit 91 transmits data between the first system bus and the second system bus, and the second bridge DMA circuit unit 90 transmits data between the first system bus and the peripheral device bus.

The encoder/decoder circuit unit 70 coupled with the first system bus is not greatly influenced by the size of an image input or displayed. Thus, a relatively slow clock signal can be used. However, the LCD/CRT controller circuit unit 40 coupled with the second system bus should drive an LCD or CRT independently, and when the size of an image displayed on the LCD or CRT is big, a fast clock signal should be applied. Therefore, in the aforementioned related art, when circuit units, which have different processing speeds due to their different clock signals, share the system bus, the speed of the entire system is set to that of the circuit unit using a slow clock signal, or the circuit unit using a fast clock signal should be in stand-by state on many occasions. It causes the degradation of the performance of the entire system, which is a disadvantage of the related art.

To overcome at least this related art disadvantage, the first bridge DMA circuit unit 91 allows each system bus to individually operate at different speeds and communicate data efficiently with each other by interfacing data transmission between the first system bus and the second system bus at different speeds. The first bridge DMA circuit unit 91 usually transmits data by a block, but can also transmit data in a smaller unit.

In the case of data transmission between the first system bus operating at a fast speed and the peripheral devices operating at a relatively slower speed, a circuit unit coupled with the first system enters the stand-by state to correspond the speed of the first system bus to that of the peripheral devices. In this case, the second bridge DMA circuit unit 90 having the same structure with the first bridge DMA circuit unit 92 interfaces between the two buses with the different speeds.

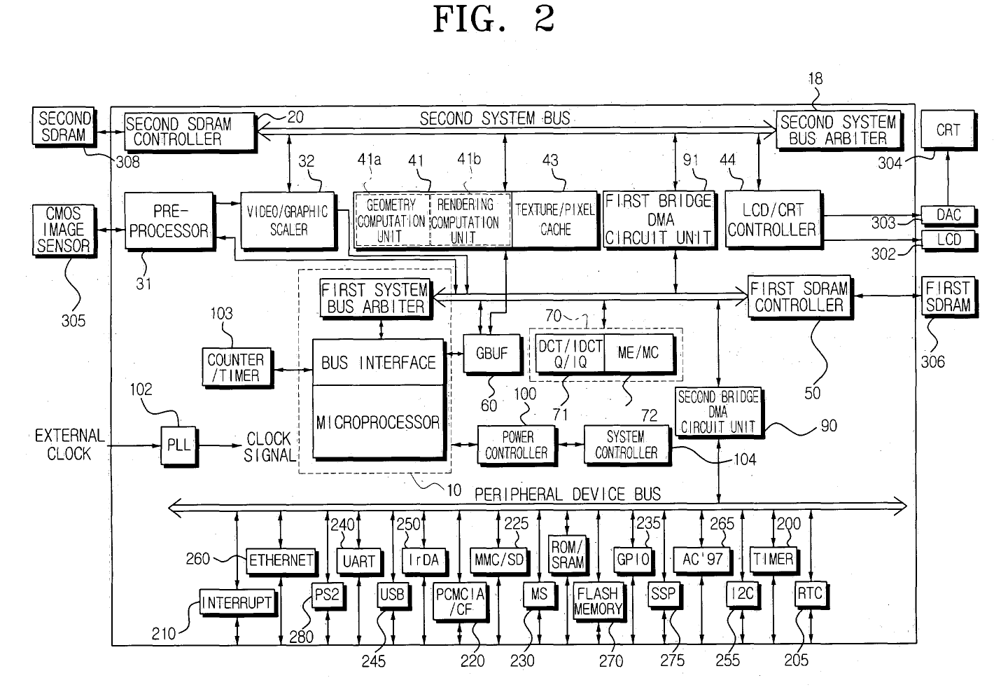

FIG. 2 is a detailed block diagram showing the SOC processor for multimedia of FIG. 1. The pre-processor circuit unit 30 (in FIG. 1) has a preprocessor 31 and a video/graphic scaler 32. The pre-processor 31 has two passages which process an image signal input from the outside and then output to the video/graphic scaler 32, and further, to output the processed image signal to the first system bus to compress a digital image signal. The preprocessor 31 processes a video signal or graphic data input-from an external camera to provide a compressed signal for the video coder or displaying apparatus, and transmits the compressed signal to the video/graphic scaler 32.

The video/graphic scaler 32 changes the size of the video signal or the graphic data transmitted from the pre-processor 31 to a size set up by a user. It is preferable that there is a key input portion (not shown) for the user to input set-up data, and the key input portion can be coupled through the peripheral device bus. However, a key input portion is not required. As a result, the various adjustments made by the user on the displayed windows can be responded to at a hardware level.

The graphic accelerator 41 is coupled with a texture/pixel cache 43 and the GBUF 60, and communicates data with an external memory storing geometry information. In an exemplary embodiment of the present invention, a second SDRAM 308 stores the information of geometry, and the graphic accelerator 41 is coupled with the second SDRAM 308 through the second system bus. It is preferable that SDRAM 308 is synchronized with the controlling unit 10 to the clock speed with the same clock frequency of the second system bus in order to communicate data easily with the graphic accelerator 41.

The graphic accelerator 41 includes a geometry computation unit 41a and a rendering computation unit 41b. A three-dimensional graphic process can be roughly divided into geometry and rendering processes. The geometry process displays an object on screen, and rendering process obtains visual effects such as color, brightness and design upon displaying the object on screen. For rendering, a hidden surface removal process and a texture process are provided. Both processes require a Z buffer and an external memory, referred to as a texture memory. The geometry computation unit 41a performs geometry processing for an input image signal, and the rendering computation unit 41b performs rendering processing for the input image signal.

The graphic accelerator 41 receives the information of geometry from the second SDRAM 308 through the second system bus for performing three-dimensional graphic processing of the input image signal. The geometry computation unit 41a performs geometry processing based on the transmitted information of geometry.

The texture/pixel cache 43 has a Z buffer (not shown) and a texture memory (not shown). The Z buffer removes a hidden surface, which is not represented by the 2D/3D graphic accelerator 41, and the texture memory stores 2D information of an object to be displayed.

The GBUF 60 is implemented by using SRAM with a dual port having fast processing speed similar to a cache memory provided inside the microprocessor 11. The GBUF 60 can operate in connection with the cache memory of the microprocessor 11, or as a supplementary buffer of other devices. In other words, when execution commands exceed the capacity of the internal cache memory of the microprocessor 11, commands in excess of the capacity of the cache memory can be stored in the GBUF 60.

The microprocessor 11 executes commands in a certain data area of the cache memory one by one until there is no data left in the cache memory, or all processes are completed. Then, the microprocessor 11 turns to the main memory and brings the next block from the main memory. When a buffer such as the GBUF 60 is used for the above computation, commands stored in the cache memory are first executed. Then, the rest of the commands can be directly executed from the GBUF 60. Therefore, the command execution time and bandwidth, for communication with an external SDRAM can be reduced, and the performance of the entire system can be upgraded.

Furthermore, the GBUF 60 can store data of an image signal to be graphic-operated by supplementing the graphic accelerator 41. In other words, the GBUF 60 can store the geometry information transmitted from the second SDRAM 308. In this case, the graphic accelerator 41 can receive the geometry information by directly accessing GBUF 60, which is directly connected with the graphic accelerator 41. Therefore, the graphic accelerator 41 can reduce time required to access to an external memory, and the efficiency of the entire system can be increased.

For three-dimensional graphic processing, texture information for expressing texture and information of the frame area for displaying is stored in a first SDRAM 306. The first SDRAM 306 can communicate data with GBUF 60 coupled with the first system bus.

The graphic accelerator 41 can directly access the GBUF 60 as they are directly connected to each other. Accordingly, when the graphic process is performed, the geometry information stored in the second SDRAM 308 may be moved to the GBUF 60. Then, the graphic accelerator 41 can reduce the time required for accessing to the second SDRAM 308. Thus, the speed of graphic processing can be upgraded. At this time, if the clock frequency of the second system bus is higher than that of the first system bus, the access speed to the controlling unit 10 of the graphic accelerator 41 becomes fast. Consequently, the performance of the entire system is improved.

The LCD/CRT controller 44 controls display of a LCD or a CRT coupled to the outside of the SOC processor. The LCD and CRT can be driven simultaneously for displaying.

The encoder/decoder circuit unit 70 comprises a DCT/IDCT (Discrete Cosine Transform/Inverse DCT) and Q/IQ (Quantization/Inverse Quantization) circuit 71, and an ME/MC (Motion Estimation/Motion Compensation) circuit 72.

For the compression of the input signal, the DCT/IDCT and Q/IQ circuit 71 segments one sheet of input image into square blocks of 8×8 pixels, and performs the DCT (Discrete Cosine Transform) and then further performs the quantization by dividing the values from the DCT by a predetermined value and rounding off the result to the nearest step value.

For the decompression of the compressed signal, the DCT/IDCT and Q/IQ circuit 71 performs inverse quantization by multiplying each value of each 8×8 pixel block by the predetermined step value, and further performs IDCT (Inverse Discrete Cosine Transform) for each inverse-quantized block.

For compressing image data, there are two methods: compressing image data within an input screen, and compressing image data by using information and relation of a consecutive screen and the input screen. The ME/MC circuit 72 compresses and decompresses image data by using information of input inter screens through motion estimation and compensation. A ME circuit of the ME/MC circuit 72 calculates a motion vector of input image signals, and a MC circuit decompress the image data by using differences between pixel values generated at a IDCT circuit of the DCT/IDCT and Q/IQ circuit 72 and pixel values of each block compensated by the motion vector. Since computations for motion estimation and compensation require the greatest amount of computations of the video CODEC, the ME/MC circuit 72 is separated in terms of hardware level and performs computations. The ME/MC circuit 72 is used in combination with the DCT/IDCT and Q/IQ circuit 71.

A power controller 100 blocks a clock signal to a circuit unit that does not require the clock signal, and provides a clock signal to a circuit unit that requires the clock signal with respect to an computation mode, so that overall power consumption can be reduced. When the power controller 100 stops the computation of the first SDRAM controller circuit unit 50 or the second SDRAM controller circuit unit 20, a refresh is required to maintain stored information. Therefore, a self-refresh mode is performed from the moment that a clock signal is blocked and becomes low. A PLL (Phase Locked Loop) 102 distributes clock signals received from the outside to circuits that require clocks under control of the power controller 101. A system controller 104 allows peripheral devices such as a camera and a LCD coupled to the outside to operate. A counter/timer 103 provides a signal required for operating the microprocessor 11.

Hereinbelow, the computation process of the SOC processor for multimedia according to an exemplary, non-limiting embodiment of the present invention will be described with reference to FIGS. 1 and 2. First, the pre-processor 31 converts an image signal input through a CMOS image sensor 305 into a signal that can be compressed, and transmits the converted input signal to the encoder/decoder circuit unit 70 through the first bridge DMA circuit unit 91. The encoder/decoder circuit unit 70 compresses and decompresses the input signal, and processed data is transmitted to the LCD/CRT controller circuit unit 44 through the first bridge DMA circuit unit 91.

The LCD/CRT controller circuit unit 44 processes input data to display the data on an LCD 302. The processed data can be further displayed on a CRT 304 through a DAC (Digital-to-Analog Converter) 303. In this process, when data needs to be stored and to be input and output, a first external SDRAM 306 or a second external SDRAM 308 are used to these ends by the first SDRAM controller circuit unit 50 or second SDRAM controller circuit unit 20.

When external apparatuses need to be controlled, the microprocessor 11 operates necessary peripheral controllers by transmitting necessary data to the peripheral device bus through the first system bus and the second bridge DMA circuit unit 90.

The GBUF 60 can be used while the microprocessor 11 is being operated. Moreover, when the microprocessor 11 encounters a command that can be computed by a circuit having an independent function during the interpretation and execution of the commands, the corresponding circuit unit is informed of the command so that it can be processed at a hardware level. Accordingly, the performance of the SOC is improved.

The presently claimed invention can be implemented in a computer readable medium, the computer readable containing a set of instructions for performing the foregoing process. As such, computer software may be provided for implementing the present invention.

The present invention has various advantages. For example, but not by way of limitation, according to the SOC processor of the present invention, three-dimensional graphic computation with respect to an input image signal is operated independently from the microprocessor, thus the load on the microprocessor is decreased, whereby the performance of the entire system is upgraded.

Although the preferred embodiment of the present invention has been described, it will be understood by those skilled in the art that the present invention should not be limited to the described preferred embodiment, but various exchanges and modifications can be made within the spirit and the scope of the present invention. Accordingly, the scope of the present invention is not limited within the described range but the following claims.

What is claimed is:

1. A system on a chip (SOC) processor for multimedia, comprising:
a pre-processor that converts an external image signal into a compressible signal;
an encoder/decoder that generates compressed data by compressing the compressible signal, and codes the compressed data to produce a coded image signal;
a post-processor that converts the coded image signal into a format for use by an image displaying apparatus;
a graphic accelerator that processes three-dimensional graphic computation with respect to the image signal output on the image displaying apparatus;
a first system bus coupled to the encoder/decoder circuit unit; and
a second system bus coupled between the pre-processor, the postprocessor, and the graphic accelerator,
wherein the first system bus and the second system bus communicate data to each other through a bridge DMA circuit unit, and a controller controls said pre-processor, said encoder/decoder, said post-processor and said graphic accelerator.

2. The SOC processor of claim 1, wherein a clock frequency of the first system bus is higher than a clock frequency of the second system bus.

3. The SOC processor of claim 1, wherein the graphic accelerator comprises:
a geometry computation unit that performs geometry computation to display an object on the image displaying apparatus; and
a rendering computation unit that performs rendering computation for visual representation of the object displayed on the image displaying apparatus with at least one of color, brightness and a design.

4. The SOC processor of claim 3, further comprising a texture/pixel cache configured to store 2-dimensional information of an object to be displayed and remove hidden surfaces of the image signal after three dimensional graphic processing.

5. The SOC processor of claim 4, further comprising a buffer coupled between the controlling unit and the first system bus, wherein the buffer is capable of storing data for graphic to support the graphic accelerator.

6. The SOC processor of claim 5, wherein the buffer is implemented by using a static random access memory (SRAM) with a dual porter.

7. The SOC processor of claim 5, wherein the buffer can receive data from an external memory having geometry information.

8. The SOC processor of claim 7, wherein the external memory is a synchronous dynamic random access memory (SDRAM) having a clock speed synchronized with that of the controlling unit.

9. The SOC processor of claim 7, wherein the graphic accelerator receives the stored information by directly accessing the buffer.

10. A method of performing multimedia processing on a system on a chip (SOC), comprising the steps of:
converting an external image signal into a compressible signal;
compressing the compressible signal to generate compressed data, and coding the compressed data to produce a coded image signal;
converting the coded image signal into a format for use by an image displaying apparatus; and
processing three-dimensional graphic computation with respect to the image signal output on the image displaying apparatus;
wherein said compressing is performed in a circuit coupled to a first system bus, and said converting steps and said processing step are performed in a circuit coupled to a second system bus, such that said first system bus and said second system bus can operate at different respective clock frequencies, and
wherein said first system bus and said second system bus communicate data to each other through a bridge DMA circuit unit, and a controller controls said converting steps, said compressing step, and said processing step.

11. The method of claim 10, wherein a clock frequency of the first system bus is higher than a clock frequency of the second system bus.

12. The method of claim 10, wherein the processing comprises:
performing geometry computation to display an object on the image displaying apparatus; and
performing rendering computation for visual representation of the object displayed on the image displaying apparatus with at least one of color, brightness and a design.

13. The method of claim 12, further comprising storing 2 dimensional information of an object to be displayed, and removing hidden surfaces of the image signal after three dimensional graphic processing.

14. The method of claim 13, further comprising storing graphic data in a buffer to support the processing step.

15. The method of claim 14, wherein the buffer is implemented by using a static random access memory (SRAM) with a dual porter.

16. The method of claim 14, wherein the buffer receives data from an external memory having geometry information.

17. The method of claim 16, wherein the external memory is a synchronous dynamic random access memory (SDRAM) having a clock speed synchronized with that of the controlling unit.

18. The method of claim 16, wherein the stored information is received in a graphic accelerator for processing by directly accessing the buffer.

19. A computer readable medium configured for storing instructions to perform multimedia processing on a system on a chip (SOC), said instructions comprising:
converting an external image signal into a compressible signal;
compressing the compressible signal to generate compressed data, and coding the compressed data to produce a coded image signal;
converting the coded image signal into a format for use by an image displaying apparatus; and
processing three-dimensional graphic computation with respect to the image signal output on the image displaying apparatus;
wherein said compressing is performed in a circuit coupled to a first system bus, and said converting instructions and said processing instruction are performed in a circuit coupled to a second system bus, such that said first system bus and said second system bus can operate at different respective clock frequencies, and
wherein said first system bus and said second system bus communicate data to each other through a bridge DMA circuit unit, and a controller controls said converting instructions, said compressing instruction, and said processing instruction.

20. The computer readable medium of claim 19, wherein a clock frequency of the first system bus is higher than a clock frequency of the second system bus.
